(19) United States
(12) Patent Application Publication
(10) Pub. No.: US 2023/0177351 A1
(43) Pub. Date: Jun. 8, 2023

(54) ACCELERATING DECISION TREE INFERENCES BASED ON TENSOR OPERATIONS

(71) Applicant: International Business Machines Corporation, Armonk, NY (US)

(72) Inventors: Nikolaos Papandreou, Thalwil (CH); Charalampos Pozidis, Thalwil (CH); Milos Stanisavljevic, Adliswil (CH); Jan Van Lunteren, Rueschlikon (CH); Thomas Parnell, Zurich (CH); Cedric Lichtenau, Stuttgart (DE); Andrew M. Sica, Oxford, CT (US)

(21) Appl. No.: 17/457,684

(22) Filed: Dec. 6, 2021

(51) Int. Cl. G06N 5/00; G06K 9/62

(52) U.S. Cl. CPC G06N 5/003; G06K 9/623; G06K 9/6201

(57) ABSTRACT

Accessing a value M identifying M top levels of one or more N decision trees, wherein 1 ≤ M < Min(L₁, ...., L_{N}) and wherein a M top levels defines top nodes for each of the N decision trees, and wherein for each decision tree Tᵢ of the N decision trees. Identifying one or more subtrees subtended by respective subsets of remaining nodes of each decision tree Tᵢ, a remaining nodes including all of the nodes of said each decision tree Tᵢ but its top nodes. Processing each of the K input records through a top nodes of said each decision tree Tᵢ to associate each of the K input records with a single, respective one of the subtrees of each decision tree Tᵢ, wherein K × N associations are obtained in total for the N decision trees and the K input records.

### BACKGROUND

The invention relates in general to the field of computer-implemented methods, computer program products, and computerized systems for accelerating decision tree inferences. In particular, the invention is directed to methods in which input records are first run only through top nodes of the decision trees, to obtain associations between the input records and subtrees of the decision trees. Such associations are then exploited in order for the subtrees to run only on a fraction of the input records, by way of tensor operations.

Decision tree learning is a predictive modelling approach used in machine learning. It relies on one or more decision trees, forming the predictive model. Decision trees are widely used machine learning algorithms, owing to their simplicity and interpretability. Different types of decision trees are known, including classification trees and regression trees. A binary decision tree is basically a structure involving coupled decision processes. Starting from the root, a feature is evaluated, and one of the two branches of the root node is selected. This procedure is repeated until a leaf node is reached, a value of which is used to assemble a final result.

Random forest and gradient boosting are important machine learning methods, which are based on binary decision trees. In such methods, multiple decision trees are “walked” in parallel until leaf nodes are reached. The results taken from the leaf nodes are then averaged (regression) or used in a majority vote (classification). Such computations can be time and resource consuming, hence a need to accelerating tree-based inference, notably for ensemble models such as random forest and gradient boosting methods.

### SUMMARY

According to a first aspect, the present invention is embodied as a computer-implemented method of performing machine learning inferences. The aim is to obtain inference results for K input records, where K ≥ 2, based on N decision trees, where N ≥ 2. Each decision tree Tᵢ of the N decision trees has nodes extending from a root node to leaf nodes across Lᵢ levels. The method first comprises accessing a value M identifying M top levels of the N decision trees, where 1 ≤ M < Min(L₁, ...., L_{N}). The M top levels include top nodes (including the root node) of each of the N decision trees. Next, two operations are performed for each decision tree Tᵢ of the N decision trees. First, subtrees are identified for each of the decision trees. The subtrees are subtended by respective subsets of remaining nodes of each decision tree Ti. Such remaining nodes include all of the nodes of each decision tree Tᵢ but its top nodes. Second, each of the K input records is processed only through the top nodes of this decision tree Tᵢ, it being understood that the same process is performed for each of the decision trees. This causes to associate each of the K input records with a single, respective one of the subtrees of each decision tree Tᵢ. Accordingly, K × N associations are obtained in total for the N decision trees and the K input records. Finally, all of the K input records are processed by executing tensor operations, in accordance with the K × N associations obtained, to perform the desired machine learning inferences. The tensor operations use first operands and second operands that capture feature values of the K input records and attributes of the remaining nodes of all of the subtrees formed, respectively.

According to another aspect, the invention is embodied as a computerized system for performing machine learning inferences. The context is the same as in the above methods. The computerized system comprises processing means, which are configured to perform steps as described above, i.e., access a value M identifying M top levels of the N decision trees, identify subtrees, process the K input records only through the top nodes of the decision trees to obtain associations between the input records and the subtrees, and finally process all of the K input records by executing tensor operations in accordance with the K × N associations obtained, based on operands that capture feature values of the K input records and attributes of nodes of the subtrees formed. The processing means of the computerized system preferably comprise one or more hardware accelerators, such as a dedicated chip, designed for tensor operations.

According to a final aspect, the invention is embodied as a computer program product for performing machine learning inferences. The computer program product comprises a computer readable storage medium having program instructions embodied therewith, where the program instructions are executable by processing means to cause the latter to perform steps according to the present methods.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 illustrates a binary decision tree, which includes split nodes and leaf nodes, as used in embodiments;

FIG. 2 shows a selection of split nodes of the decision tree of FIG. 1, together with node attributes (feature identifiers and threshold values), which are used to execute such nodes, as in embodiments;

FIGS. 3A and 3B illustrate how the evaluation of a decision tree (FIG. 3A) can be cast as a series (FIG. 3B) of three matrix multiplication operations interleaved by two element-wise logical operations, according to a prior technique. Although the decision tree-processing illustrated in FIG. 3B is not according to this invention, it is nevertheless useful to understand concepts involved in embodiments of the invention;

FIGS. 4A and 4B are diagrams illustrating how input records can be run only through a top node of a decision tree, to obtain associations between these input records and respective subtrees. Such associations are then exploited for the subtrees to run only on a fraction of the input records, by way of tensor operations, which makes it possible to eliminate operations related to certain sub-matrices, as in embodiments;

FIG. 5 is a flowchart illustrating high-level steps of a method of performing machine learning inferences, according to embodiments;

FIG. 6 is another flowchart illustrating a preferred implementation of steps S50 and S60 of the flowchart of FIG. 5, as in embodiments;

FIG. 7 schematically represents a general-purpose computerized unit, suited for implementing one or more method steps as involved in embodiments of the invention; and

FIG. 8 schematically depicts a computerized system, including a unit such as shown in FIG. 7, as well as a hardware accelerator, to which tensor operations can be offloaded, as in embodiments of the invention.

The accompanying drawings show simplified representations of devices or parts thereof, as involved in embodiments. Similar or functionally similar elements in the figures have been allocated the same numeral references, unless otherwise indicated.

Computerized systems, methods, and computer program products embodying the present invention will now be described, by way of non-limiting examples.

### DETAILED DESCRIPTION OF EMBODIMENTS OF THE INVENTION

Several approaches have been proposed to accelerate tree-based inferences, by optimizing hardware and/or algorithmic characteristics. In general, accelerating tree-based inferences is achieved by speeding up either (i) the individual decision tree processing, and/or (ii) the parallel processing of multiple decision trees.

For example, a method has been proposed, which allows decision trees to be executed by way of tensor operations. I.e., the evaluation of a decision tree is cast as a series of three matrix multiplication operations interleaved by two element-wise logical operations.

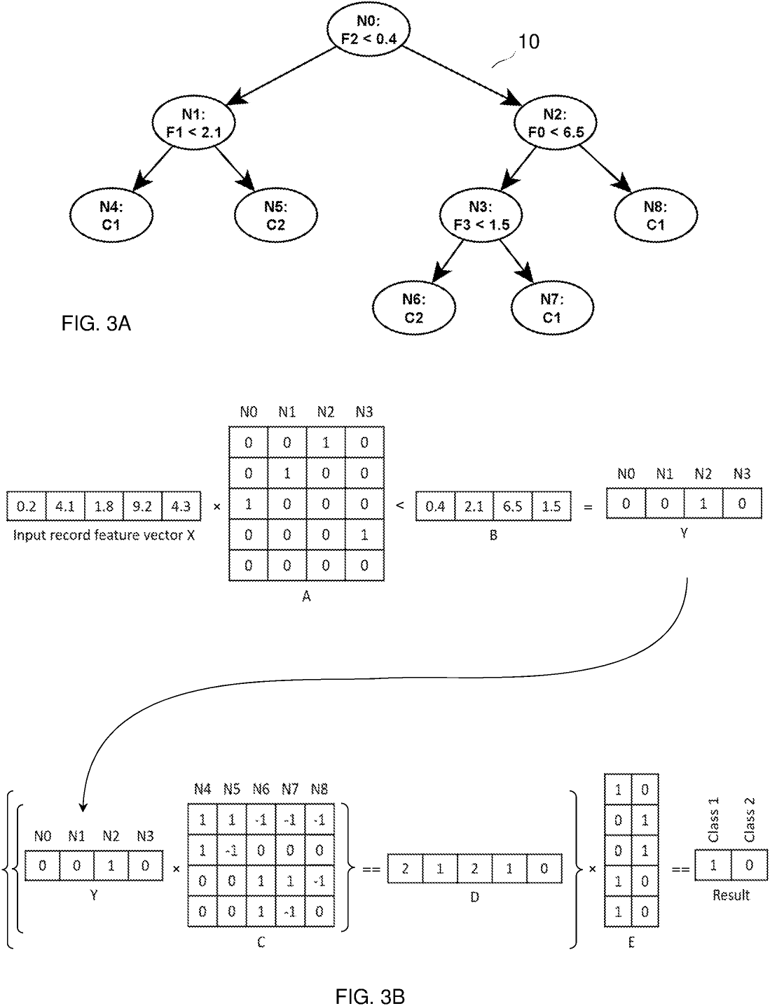

In detail, the tensor operations are decomposed into five operations for each input record and each decision tree. These operations make use of five matrices (A, B, C, D, and E) representing the structure of the decision tree. FIG. 3B shows how the decision tree 10 of FIG. 3A can be evaluated based on the above matrices for a given input record. The vector X captures feature values of this input record. The matrix A captures relationship between input features and split nodes (also called internal nodes) of the tree 10. The number of columns of matrix A corresponds to the number of split nodes of the tree 10. In the purposely simple example of FIG. 3A, the tree considered has only four split nodes N0, N1, N2, and N3, which result in four columns for matrix A. Vector B includes comparands which are set to the threshold values of the split nodes of the tree 10. Matrix C captures, for any leaf node and internal node pair, whether the internal node is a parent of that leaf node, and if so, whether it is in the left or right subtree. The number of columns of matrix C corresponds to the number of leaf nodes of the tree 10. In the example of FIG. 3A, the tree considered has five leaf nodes N4, N5, N6, N7, and N8, which result in five columns for matrix C. Vector D includes second comparands, each corresponding to the count of internal nodes in the path from a respective leaf node to the tree root, for which the internal node is the left child of its parent. Matrix E maps leaf nodes to class labels.

Using matrices as described above, the tensor operations can be decomposed into a sequence of five operations for each input record and each decision tree. Such operations start with a dot product of the row vector X by the matrix A, see FIG. 3B. This yields a first result (a row vector), which is subsequently compared (second operation) to the row vector B. This leads to a second result, captured by row vector Y. The third operation is a dot product of the row vector Y by matrix C. This yields a third result (another row vector), which is compared (fourth operation) with the row vector D. This provides a fourth result, i.e., a row vector Z, not explicitly shown in FIG. 3B. The last operation is a dot product of the row vector Z by the matrix E, which results in a fifth result (a row vector). The fifth result represents an inference result, corresponding to the outcome of executing the tree 10 with respect to the input record X.

The technique is appealing as it allows decision trees to be executed as a set of tensor operations. However, a direct application of such tensor operations to large numbers of input records and decision trees (as involved in ensemble models) will remain computationally costly.

Embodiments of the present invention provide for tensor operations can advantageously be offloaded to a hardware accelerator. They may for instance be offloaded to a dedicated chip, which is specifically designed to perform tensor operations. The optimal number of top levels may be determined based on computer resources available at the computerized system used to perform the method, e.g., by comparing the additional computational complexity induced by the processing of the K input records through the top nodes with the expected reduction of computational complexity allowed by the associations obtained and the second operands used to execute the tensor operations.

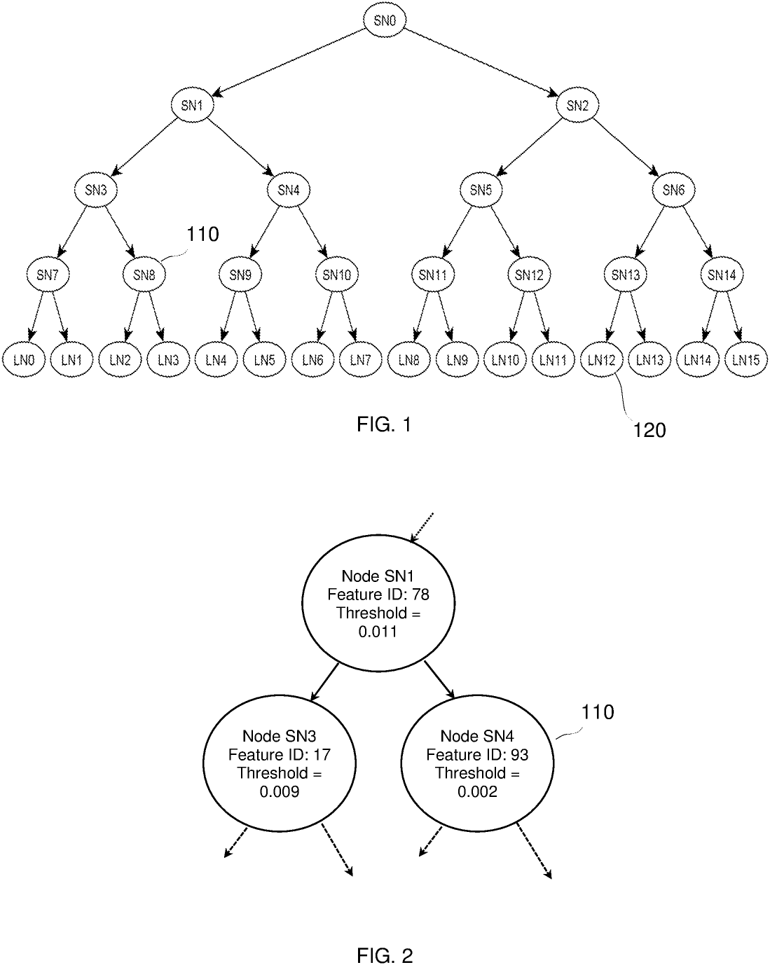

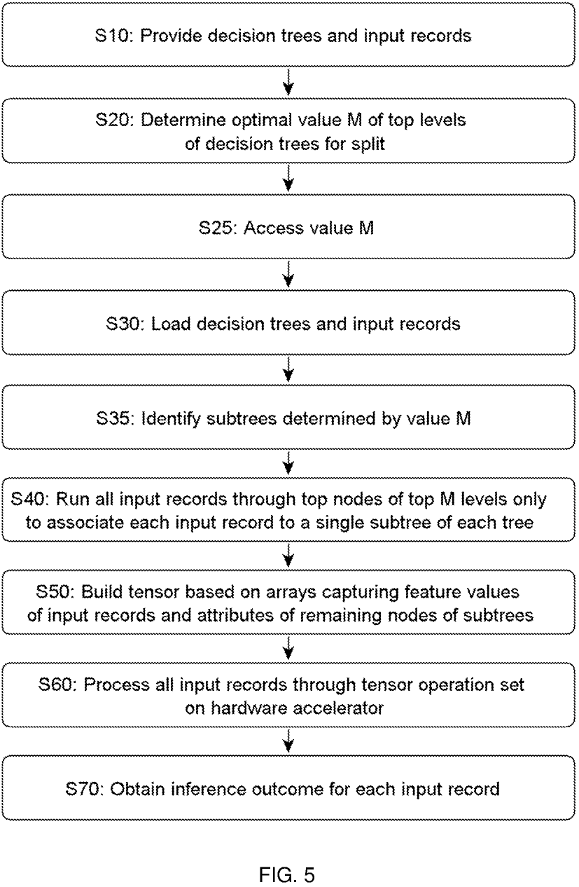

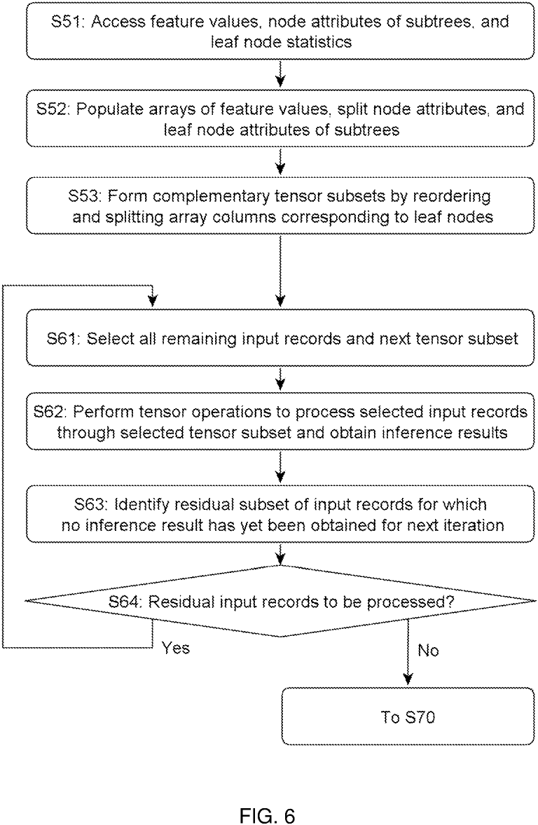

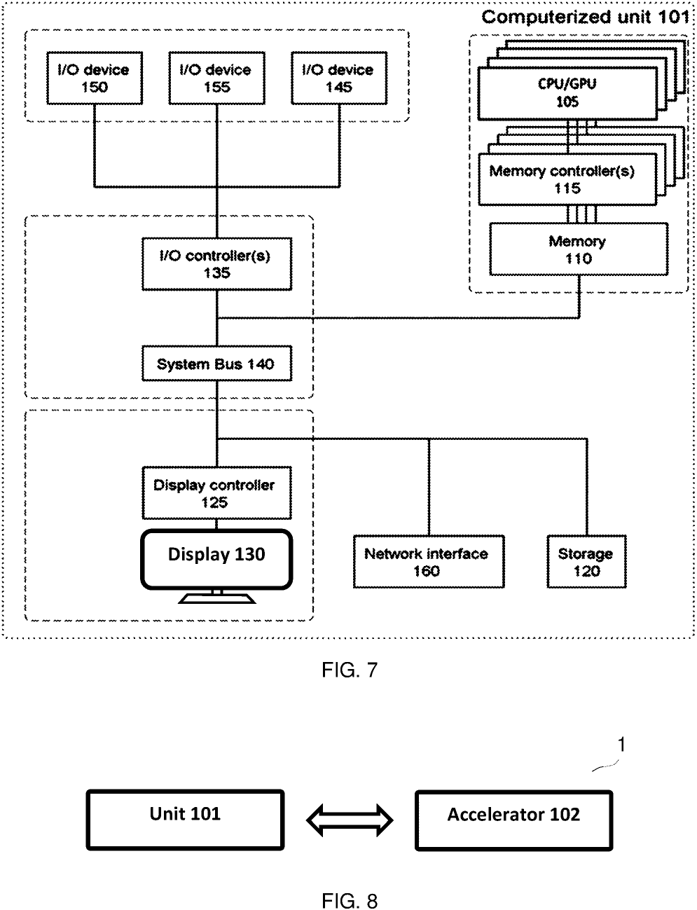

A first aspect of the invention is now described in detail in reference to FIGS. 1 -6. This aspect concerns a computer-implemented method. Note, this method and its variants are collectively referred to as the “present methods”. All references Sn refer to methods steps of the flowcharts of FIGS. 5 and 6, while numeral references pertain to mathematical objects, corresponding data structures (such as arrays including node attributes and input features), FIG. 1 - 4B, or physical parts or components of the unit and system shown in FIGS. 7 and 8.

The method aims at performing machine learning inferences, using decision trees. The context assumed is the following: K input records are to be processed through N decision trees, where K ≥ 2 and N ≥ 2. As illustrated in FIG. 1, each decision tree Tᵢ of the N decision trees has nodes 110, 120 extending from a root node to leaf nodes and, this, across Lᵢ levels. The decision trees do not necessarily all have the same number of levels. The nodes include split nodes 110 (also known as internal nodes) and leaf nodes 120. The split nodes 110 are also denoted by references SN0 (corresponding to the root node) to SN14, while the leaf nodes 120 are denoted by references LN0 to LN15 in the example of FIG. 1.

Each node has attributes, which include operands (as required to execute the nodes), feature identifiers (also called feature selectors), and thresholds (used for comparisons). More generally, the node attributes may include all arguments/parameters needed for evaluating the rules captured by the decision tree nodes. Each split node of a decision tree is labelled with a feature identifier and is associated with a threshold to perform an operation, whereby, e.g., a feature value corresponding to a feature identifier is compared to a threshold, as known per se. This is illustrated in FIG. 2, which depicts selected split nodes 110 of the tree shown in FIG. 1, together with respective feature identifier values (“feature ID”) and threshold values.

The aim of the present method is to perform machine learning inferences by way of tensor operations. Several types of tensor operation decompositions can be contemplated, such as the decomposition. Other, albeit similar, tensor decompositions may be devised, as the skilled person may realize. For instance, the matrices may be adapted to non-binary trees and map more than two classes, or to allow predictions to be formed instead of classes. Such tensor decompositions make it possible to process each input record through each of the decision trees, using tensor operations involving node attributes of all of the decision trees, in their entirety. As one understands, this can remain computationally costly when large numbers of input records and decision trees are involved. The present inventors accordingly devised novel and improved techniques to perform machine learning inferences.

Namely, the approach proposed by the present inventors is to first run the input records only through top nodes of the N decision trees. Associations are accordingly obtained between the input records and respective residual subtrees. Such associations are then exploited in order for the subtrees to run only on a fraction of the input records, by way of tensor operations such as described above. This effectively reduces the computation workload.

In more detail, a value M is accessed (step S25 in the flowchart of FIG. 5), which identifies M top levels of the N decision trees, where 1 ≤ M < Min(L₁, ...., L_{N}). As said, L₁, .... , L_{N}, refer to the numbers of levels of respective decision trees Tᵢ, where i = 1, ..., N. The trees include at least two levels (likely more) but may have different numbers of levels. The number M of top levels, however, is the same for each of the N decision trees. Each decision tree Tᵢ includes T_{N,i} top nodes in its M top levels.

Typically, the decision trees involved are binary decision trees, such that the number T_{N,i} will typically be the same for all decision trees, being equal to 2^{M} - 1. However, some nodes may be “missing” in some levels of some of the decision trees. Thus, the number T_{N,i} of top nodes is at most equal 2^{M} - 1, i.e., 1 ≤ T_{N,i} ≤ 2^{M} - 1, even in the case of binary trees. Still, the trees may possibly involve non-binary nodes. In the following, though, the decision trees are assumed to be regular binary trees, for simplicity. Moreover, the number T_{N,i} is assumed to be the same for all of the N decision trees involved, again for simplicity. That is, T_{N,i} = T_{T} = 2^{M} - 1 ∀ i ∈ {1, ...,N}.

Next, two steps (steps S35 and S40 in the flowchart of FIG. 5) are performed in order to identify subtrees and associations between the input records and the subtrees identified. Namely, subtrees are identified (step S35) for each decision tree Tᵢ. Note, T_{T} + 1 = 2^{M} subtrees are identified for each decision tree, assuming it is a regular binary tree. These subtrees are subtended by respective subsets of remaining nodes of each decision tree Tᵢ. The remaining nodes include all of the nodes of the decision tree Tᵢ but its T_{T} top nodes. Accordingly, N x (T_{T} + 1) subtrees are identified in total for the N decision trees, assuming that the number M of top levels selected results in a same number of top nodes in each tree. Furthermore, each of the K input records is processed (step S40) through the T_{T} top nodes of each decision tree Tᵢ. This partial processing results in that each input record “goes” to a single output branch of one of the top nodes of the decision tree (normally a node located at level M). Thus, this input record can be associated to a single subtree of each decision tree. This procedure leads to associate each of the K input records with a single, respective one of the T_{T} + 1 subtrees of each decision tree Tᵢ. Accordingly, K × N associations are obtained in total for the N decision trees and the K input records.

Finally, the K × N associations obtained are exploited to perform the machine learning inferences. Namely, all of the K input records are processed S60 by executing tensor operations in accordance with the K × N associations obtained, and thanks to tensor operands capturing all the residual information needed. A tensor is an algebraic object that can be represented as a multidimensional array. This object describes relationships between sets of algebraic objects related to a given vector space. A tensor may for instance map a vector (a 1-dimensional tensor) or a matrix (a 2-dimensional tensor). In the present context, the tensor operations typically rely on tensor sets and tensor subsets, which map collections of vectors and matrices, from which operands are extracted to perform the operations.

More precisely, the tensor operations use first operands, which capture feature values of the K input records, and second operands, which capture attributes of the remaining nodes of all of the subtrees formed, e.g., the N × (T_{T} + 1) subtrees formed, assuming that the number T_{T} of top nodes is the same for all trees. These operands are formed based on arrays that may have various dimensions. Such dimensions are determined by the number K of the input records, the numbers of features associated with the input records, the number of subtrees involved, and the numbers of nodes in these subtrees.

The tensor operations are further performed with the K × N associations obtained, so as to rightly map the input records to the respectively associated subtrees. That is, the K × N associations are exploited in such a manner that the tensor computations performed amount to effectively running each of the K input records though the single subtree respectively associated therewith and, this, for each decision tree Tᵢ of the N decision trees. In other words, given a value M, the method may for example identify N × 2^{M} subtrees, and each of the K input records is associated with a respective one of the 2^{M} subtrees identified and, this, for each of the N trees. I.e., if the j^{th} subtree generated within the i^{th} tree is denoted by ST_{i,j}, then there is an association between any input record k ∈ {1, ..., K} with subtree ST_{i,j}, and all such associations are taken into account to judiciously perform the tensor operations.

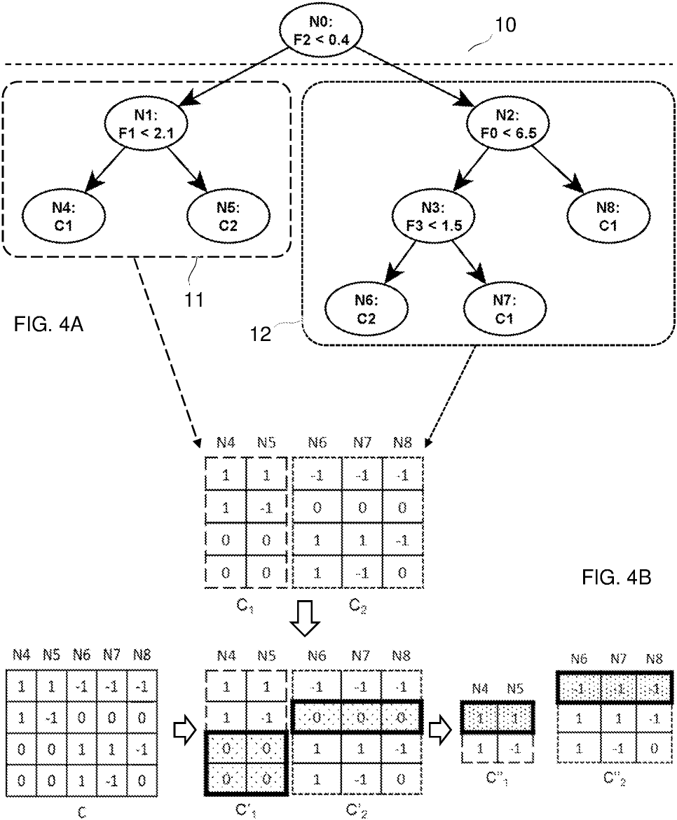

As per the proposed method, once the input records have been run through the top nodes of the trees (which operation is not expensive, computationally speaking), each subtree runs only on a fraction of the input records, thanks to the associations formed. That is, for each initial tree, each input record is run through a single subtree only, i.e., through a fraction of the paths of this initial tree. In practice, this means that the tensor dimensions can be reduced. E.g., when using a tensor decomposition such as shown in FIG. 3B, this means that the dimensions of matrices A, B, C, D, and E can be reduced for each sub-problem, as illustrated in FIG. 4B for one particular type of matrix.

The present approach can be extended to support multi-class and regression tasks. Where tree ensembles are involved, matrices similar to matrices A, B, C, D, and E can be created for each subtree and batched to produce 3D tensors. As the number of leaf nodes and internal nodes may vary from one subtree to the other, the tensor dimensions are determined by the maximum number of leaf nodes and internal nodes of all of the subtrees involved, while smaller matrix slices are padded with zeros. Conversely, if the input matrix contains batches with multiple records, then all required operations can be performed using batched variants of matrix operations such as shown in FIG. 3B. Thus, global tensors can be used, which can notably be formed as 3D tensors that can be zero-padded, where necessary, according to maximal dimensions of the subtrees. Yet, such tensors can also be conveniently pruned, where possible. E.g., calculations corresponding to zero sub-matrices (corresponding to nodes not present in a subtree) can be skipped, thus saving unnecessary computations. In the example of FIG. 4B, the calculations that can be skipped are those corresponding to highlighted sub-matrices (with a patterned fill and bold borders).

The present approach can advantageously be applied to ensemble models, including Gradient Boosting and Random Forests. That is, the N decision trees may form part of an ensemble model. In that case, the machine learning inferences are performed to obtain an ensemble result for each of the K input records. E.g., each of the N decision trees may be a binary classification tree and each ensemble result obtained may be a classification result. In variants, each of the N decision trees is a binary regression tree and each ensemble result is obtained as a regression result.

The present methods can leverage hardware accelerators to perform the tensor operations. That is, the tensor operations may be offloaded to a hardware accelerator for execution. This accelerator may for instance includes a dedicated chip, specifically designed to perform tensor operations such as matrix operations. In variants, the accelerator may include field programmable gate arrays (FPGAs). In both cases, offloading the tensor operations to specialized hardware results in substantially improving the time efficiency of the computations.

In preferred embodiments, the number M of top levels is optimized, prior to identifying the subtrees. That is, an optimal number of top levels can be determined (at step S20), based on, e.g., computer resources available at the computerized system 1 used to perform the present methods. This system 1 concerns another aspect of the invention, which is described later in detail. The optimal number M must be such that 1 ≤ M < Min(L₁, ...., L_{N}). This number is then stored and later accessed at step S25. In general, the available computer resources may typically be translated into an optimal or maximum size of matrices supported by the underlying system 1, the latter possibly including a hardware accelerator.

In particularly preferred embodiments, the optimal number M of top levels is determined based on the optimal or maximum size of matrices supported by the hardware accelerator used, as evoked above. In variants, the determination of the optimal number M of top levels is performed by comparing the additional computational complexity induced by the processing of the K input records through the top nodes of each of the decision trees with the reduction of computational complexity that can be expected by leveraging the K × N associations obtained and the second operands to execute the tensor operations. In other words, a trade-off in computational performance of the computerized system is found between the reduced computational complexity enabled by the subtrees and the added complexity of the initial M-level comparisons. More generally, the optimal number M of top levels can be determined based on: (i) the optimal or maximum size of matrices supported by the hardware accelerator and/or (ii) the above trade-off in performance.

In simpler variants, the value M may be preset. For example, the number can be set to M = 1 for each decision tree. I.e., one top level only is first considered, for each of the N decision trees, for the purpose of identifying subtrees. The top level is the level corresponding to the root node and thus includes a single top node. This also means that only two subtrees are identified, for each decision tree, and each of the two subtrees corresponds to a respective subset of the remaining nodes of the tree. The value M may also be a configurable parameter, set by the user.

In practice, the present methods are preferably performed by loading arrays capturing all required data in the main memory of the computerized system 1. Such arrays include first arrays capturing feature values of the K input records for use by the first operands. For example, the first arrays loaded may comprise an array x for each input record of the K input records. In that case, each array x reflects a row vector X including the feature values of a respective input record, as shown in FIG. 3B for a particular input record. That is, each of the first arrays may be decomposed into input vectors X, each including input feature values. Such arrays may for instance be grouped in 2D arrays (matrices) associated to respective subtrees, as necessary to subsequently process each input record against a respective subtree and, this, for each decision tree. That is, the first arrays may differ for each subtree of the second arrays (see below), given that each subtree is associated with a respective subset of the K input records, owing to the operations performed at step S40.

Further arrays can be loaded, which capture attributes of the remaining nodes of the trees, i.e., the nodes subtending the subtrees formed, for use by the second operands. As said, there are typically N × (T_{T} + 1) such subtrees in total. For example, such arrays may include: second arrays, which capture attributes of split nodes of the subtrees; and third arrays, which capture attributes of leaf nodes of the subtrees.

The second and third arrays may notably correspond to vectors and matrices that are similar to those shown in FIG. 3B. However, one should keep in mind that, in the context of the present embodiments, the vectors and matrices corresponding to the second and third arrays are applied to subtrees 11, 12, in accordance with associations found, and not to full decision trees 10. The distinction is illustrated in FIG. 4B for one particular type of arrays, which is described later in detail.

The second arrays may notably comprise two arrays for each subtree of the N × (T_{T} + 1) subtrees formed, including an array a reflecting a matrix A and an array b reflecting a row vector B of first comparands. As indicated earlier, matrix A captures relationship between input features and split nodes (or internal nodes) of a given subtree; its columns correspond to split nodes of this subtree, whereas the comparands in vector B are set to the threshold values of the split nodes of this subtree.

Similarly, the third arrays may include thee arrays c, d, and e for each subtree. These arrays can respectively be represented as matrices C, D, and E. The array c reflects a matrix C, the number of columns of which corresponds to a number of leaf nodes of each subtree. Matrix C captures, for any leaf node and internal node pair, whether the internal node is a parent of that leaf node, and if so, whether the path to the leaf node includes a left or right branch from that internal node. The array d reflects a row vector D of second comparands, each corresponding to the count of the internal nodes in the path from a respective leaf node to the tree root, for which the internal node is the left child of its parent. The array e reflects a matrix E encoding potential inference results. E.g., it maps leaf nodes to class labels.

Using a matrix decomposition as described above, the tensor operations can be decomposed into a sequence of five operations for each input record and each subtree, as in the example of FIG. 3B. Such operations start with a dot product of the row vector X by the matrix A. This results in a first result (a row vector), which is subsequently compared (second operation) to the row vector B. This leads to a second result: the row vector Y. That is, the machine obtains an array y of values, which encode the outcome of this comparison, and the array y can be represented as a row vector Y. The third operation is a dot product of the row vector Y by the matrix C. This yields a third result (another row vector), which is compared (fourth operation) with the row vector D. This leads to a fourth result, i.e., an array z, which encodes an outcome of the last comparison. The array z reflects a row vector Z (not shown). The last operation is a dot product of the row vector Z by the matrix E, which results in a fifth result as a row vector. The fifth result is finally used to produce an inference result, which represents an outcome of executing a given subtree with respect to a given input record.

In the above example, the operations are cast as a series of three matrix multiplication operations interleaved by two element-wise logical operations. However, in the present context, the tensor operations are applied to subtrees, in accordance with certain associations, and not to full decision trees.

This distinction is now discussed in reference to FIGS. 4A and 4B. Here, the number M of top level is assumed to be set to 1, such that two subtrees 11, 12 are identified for each decision tree 10. Consider, for example, the matrix C, which corresponds to the full tree 10 in the context of FIG. 3A. In the context of subtrees, however, this matrix can advantageously be decomposed into two sub-matrices C₁ and C₂, respectively corresponding to the two subtrees 11, 12. That is, the two subtrees 11, 12 are translated into two sub-matrices C₁ and C₂ (the matrices C₁ and C₂ are sub-matrices of the initial matrix C), where each matrix C₁, C₂ has a number of columns corresponding to the number of leaf nodes in the respective subtrees 11, 12.

The zero sub-matrices can safely be pruned; they correspond to patterned areas in the matrices C′₁ and C′₂ shown under the matrices C₁ and C₂ in FIG. 4B. More precisely, the patterned areas in the matrices C′₁ and C′₂ correspond to internal nodes in the original tree that are not present in the individual subtrees. Removing these useless portions results in the matrices C″1 and C″2 shown on the right-hand side. Next, the first row of each of the matrices C″1 and C″2 can be eliminated too, since it corresponds to operations related to the root node, which are not needed in the two subtrees 11, 12. Similar simplifications can be achieved when subdividing the other arrays A, B, D, and E. The resulting arrays can then be grouped into tensors. Conversely, tensors may initially be formed based on all required data, padded where needed, and then conveniently be pruned. The above example illustrates how, starting from full matrices, calculations can be simplified by: (i) running the input records only through top nodes of the trees, (ii) associating the input records with the residual subtrees, and (iii) then executing the subtrees using tensor operations.

Yet, a further optimization can be contemplated, by decomposing the residual tensor operations involved into subgroups. This optimization exploits statistics on the leaf nodes of the decision trees to form complementary tensor subsets (still taking account of the associations formed at step S40) in accordance with such statistics. The complementary tensor subsets are ranked according to such statistics, which makes it possible to perform the required tensor operations by way of an iterative process, as now discussed in reference to FIG. 6.

Namely, the present methods may build a tensor representation of the inferences to be performed by forming complementary tensor subsets. The complementary tensor subsets are still formed in accordance with the K × N associations obtained, yet in such a manner as for the subsets to respectively correspond to complementary subsets of the leaf nodes of the N × (T_{T} + 1) subtrees formed (assuming binary trees). This tensor representation is built at steps S51 - S53, based on statistics on nodes of the N decision trees and the further arrays, prior to execution.

Moreover, the complementary tensor subsets obtained are ranked in order of likelihood for the corresponding leaf nodes to be reached. That is, the complementary tensor subsets are ranked in such a way that a first and second tensor subsets of the complementary tensor subsets correspond to a first subset and a second subset of leaf nodes of the complementary leaf node subsets, respectively. Here, leaf nodes of the first leaf node subset are more likely to be reached than the leaf nodes of the second leaf node subset, according to the statistics accessed.

In that case, the tensor operations can be executed by first processing (steps S61 -S62) all of the K input records through the first tensor subset, taking care of the K × N associations formed, so as for input records to rightly go to respective subtrees. That is, tensor operations of the first tensor subset are first performed S62 on all input records (suitably mapped to respective subtrees) to obtain first inference results. The latter concern only a first subset of the K input records; they are obtained in accordance with leaf nodes of the first leaf node subset. At this point, some input records remain, for which no inference result has yet been obtained. The remaining input records form a second subset of the set of input records and are identified at step S63.

Next, all of the remaining input records are processed S61 - S62 by performing S62 the tensor operations of the second tensor subset. Note, this is performed in accordance with a corresponding, residual subset of the K × N associations previously obtained, again to correctly map the residual input records. This yields second inference results for the second subset of the input records. The second inference results are obtained in accordance with leaf nodes of the second leaf node subset. If only two complementary tensor subsets are initially formed, then the iterative process stops after the second iteration. In variants, more than complementary tensor subsets may be formed, leading to a larger number of iterations.

The statistics used may notably be statistics on the leaf nodes of the initial decision trees 10, which remain valid for the leaf nodes of the subtrees 11, 12. For example, such statistics may reflect a propensity of the leaf nodes to be reached upon running the decision trees. E.g., such statistics may be based on the numbers of times the leaf nodes are reached upon running the decision trees. More generally, such statistics may be statistics on decision paths in the decision trees, which can nevertheless be translated to statistics as to the sole leaf nodes. Such statistics are typically obtained while training the decision trees, although they may be refined during validations or inferences. That is, the statistics may be updated at runtime, while processing new input records through the first tensor operation subset and the second tensor operation subset. This way, a new decomposition of the tensor operation set can be achieved based on updated statistics. I.e., subsequent operations will thus be based on new subsets of tensor operations.

The above improvement is all the more advantageous when the maximal tree depth increases, typically when one or more of the subtrees involved have a depth that is larger than or equal to six.

Note, the tensor subsets can be regarded as aggregating multiple arrays, adequately zero-padded to compensate for the differences of dimensions of the subtrees. The complementary tensor subsets can for instance be formed S53 by reordering the columns or rows of the third arrays (depending on the matrix dimension that is related to the leaf nodes) and then splitting the columns (or rows) of the third arrays as reordered. That is, the columns (or rows) of the third arrays are reordered according to the statistics accessed; such columns (or rows) correspond to respective leaf nodes of the subtrees. Next, the columns (or rows) of the third arrays (once reordered) are split to obtain complementary subarrays. The third arrays have been described earlier; they include first subarrays and second subarrays. The first tensor subset is formed based on the first subarrays, while the second tensor subset is formed based on the second subarrays. For instance, the third arrays, once reordered, can be split according to at least one threshold value in respect of the statistics accessed for the leaf nodes. By construction, each threshold value is unique for all the subtrees. As noted above, more than two complementary tensor subsets may possibly be formed, e.g., using distinct threshold values. By construction, each threshold value is unique for all the subtrees. In variants, distinct threshold values may be used.

The above embodiments have been succinctly described in reference to the accompanying drawings and may accommodate a number of variants. Several combinations of the above features may be contemplated. This is exemplified in the following, which describes preferred flows in reference to the flowcharts of FIGS. 5 and 6.

First, pre-processing steps are performed, in order to set the initial decision trees, learn the decision tree based on training data, and run the decision trees as learned based on validation and/or training data to aggregate statistics on leaf nodes. Next, decision trees and input records are provided at step S10 (FIG. 5), in order to determine (step S20) an optimal value M of top levels of the decision trees to set the split (based on available resources, by seeking a trade-off in computational performance). This value is stored and later accessed at step S25.

The decision trees are then processed with a view to performing inferences. Input records and decision trees are all loaded (step S30) in the main memory, if possible. In variant, an iterative process may be used, should the computer resources prevent simultaneously loading such data. At step S35, subtrees are determined according to the value M. All input records are first run through the top nodes of the top M levels (step S40), which eventually causes to associate each of the input records to a single subtree of each of the decision trees. Next, a tensor representation of the problem is built at step S50, based on arrays capturing feature values of the input records and attributes of nodes of the sole subtrees involved. Such tensors are suitably padded (where needed) and pruned (where possible). All input records are then processed (step S60) through the tensor operation set obtained, in accordance with the associations formed. Such processing may be partly performed using parallelism and/or using vector processing capability of the CPUs/GPUs 105, see FIG. 7. In variants, this operation is offloaded to a hardware accelerator 102 (FIG. 8), which may possibly use parallelism/vector processing too. This makes it possible to obtain inference results for all of the input records (step S70), based on which an ensemble result may subsequently be obtained (e.g., as a majority vote).

Steps S50 and S60 aim at processing input records through a set of subtrees, using a tensor operation set. Now, this is preferably done in several stages, using an iterative process, as now described in reference to FIG. 6. Namely, feature values (input records), node attributes of the subtrees, and leaf node statistics, are accessed at step S51. The feature values and node attributes accessed are used to form S52 arrays capturing the feature values, the split node attributes, and the leaf node attributes of the subtrees. Such arrays are then used to form S53 at least two complementary tensor subsets. This is achieved by reordering and splitting array columns corresponding to leaf nodes of subtrees, based on the statistics accessed at step S51. This way, complementary tensor operation subsets are built, which are then exploited perform the step-by-step process of steps S61 - S63. That is, all input records are selected, together with the first tensor operation subset, step S61, in order to perform S62 tensor operations, taking care of the associations obtained, so as to correctly map the input records. I.e., the currently selected input records (initially all of them) are processed through the selected tensor subset, in order to obtain first inference results. Next, the process attempts to identify S63 a residual subset of input records for which no inference result has yet been obtained, with a view to performing the next iteration. If it is indeed determined (S64: Yes) that residual input records need be processed, the process loops back to step S61. I.e., all the remaining input records are selected, together with the next tensor operation subset, step S61, and so on. After all input records have been processed (step S63: No), inference outcomes are gathered at step S70.

Next, according to another aspect, the invention can be embodied as a computer program product for performing machine learning inferences. This computer program product comprises a computer readable storage medium having program instructions embodied therewith. The program instructions are executable by processing means 102, 105 of a computerized system 1, 101, such as described below, so as to cause such processing means to perform steps as described earlier in reference to the present methods. In particular, such instructions may cause the computerized system to take advantage of hardware accelerators to perform tensor operations, as discussed earlier.

Referring to FIGS. 7 and 8, a further aspect of the invention is now described, which concerns a computerized system 1, 101 for performing machine learning inferences. The system 1 typically comprises storage means 120, which stores computerized methods (e.g., in the form of software). In operation, such computerized methods can be loaded in the main memory 110, for the processing means 102, 105 to cause to perform steps according to the present methods.

In the example of FIG. 7, the system is a computerized unit 101, the processing means of which includes central processing units (CPUs) and graphics processing units (GPUs), both of which may be used to perform computations required by the present methods. In advantageous variants such as depicted in FIG. 8, the system 1 includes both a standard computerized unit such as unit 101 shown in FIG. 7 and one or more hardware accelerators 102. In that case, the system 1 may be configured to offload the tensor operations to the one or more hardware accelerators. The latter may notably include FPGAs and/or a dedicated chip, specifically designed for tensor operations.

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, FIG. 7 schematically represents a computerized unit 101 (e.g., a general- or specific-purpose computer), which may possibly interact with other, similar units, so as to be able to perform steps according to the present methods.

In exemplary embodiments, in terms of hardware architecture, as shown in FIG. 7, each unit 101 includes at least one processor 105, and a memory 110 coupled to a memory controller 115. Several processors (CPUs, and/or GPUs) may possibly be involved in each unit 101. To that aim, each CPU/GPU may be assigned a respective memory controller, as known per se. In variants, controllers of the unit 101 may be coupled to FPGAs or other hardware accelerators, as discussed earlier in reference to FIG. 8.

One or more input and/or output (I/O) devices 145, 150, 155 (or peripherals) are communicatively coupled via a local input/output controller 135. The input/output controller 135 can be coupled to or include one or more buses and a system bus 140, as known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processors 105 are hardware devices for executing software instructions. The processors 105 can be any custom made or commercially available processor(s). In general, they may involve any type of semiconductor-based microprocessor (in the form of a microchip or chip set), or generally any device for executing software instructions.

The memory 110 typically includes volatile memory elements (e.g., random-access memory), and may further include nonvolatile memory elements. Moreover, the memory 110 may incorporate electronic, magnetic, optical, and/or other types of storage media.

Software in memory 110 may include one or more separate programs, each of which comprises executable instructions for implementing logical functions. In the example of FIG. 7, instructions loaded in the memory 110 may include instructions arising from the execution of the computerized methods described herein in accordance with exemplary embodiments. The memory 110 may further load a suitable operating system (OS) 111. The OS 111 essentially controls the execution of other computer programs or instructions and provides scheduling, input-output control, file and data management, memory management, and communication control and related services.

Possibly, a conventional keyboard and mouse can be coupled to the input/output controller 135. Other I/O devices 140 - 155 may be included. The computerized unit 101 can further include a display controller 125 coupled to a display 130. Any computerized unit 101 will typically include a network interface or transceiver 160 for coupling to a network, to enable, in turn, data communication to/from other, external components, e.g., other units 101.

The network transmits and receives data between a given unit 101 and other devices 101. The network may possibly be implemented in a wireless fashion, e.g., using wireless protocols and technologies, such as Wifi, WiMax, etc. The network may notably be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given unit 101 and any external unit, via a broadband connection. In exemplary embodiments, network can be a managed IP network administered by a service provider. Besides, the network can be a packet-switched network such as a LAN, WAN, Internet network, an Internet of things network, etc.

The present invention may thus be a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant, or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A computer-implemented method of performing machine learning inferences on K input records, K ≥ 2, based on N decision trees, N ≥ 2, wherein each decision tree Tᵢ of the N decision trees has nodes extending from a root node to leaf nodes across Lᵢ levels, wherein the method comprises:
accessing, by one or more computer processors, a value M identifying M top levels of one or more N decision trees, wherein 1 ≤ M < Min(L₁, ...., L_{N}) and wherein a M top levels defines top nodes for each of the N decision trees, and wherein for each decision tree Tᵢ of the N decision trees:
identifying, by one or more computer processors, one or more subtrees subtended by respective subsets of remaining nodes of each decision tree Tᵢ, a remaining nodes including all of the nodes of said each decision tree Tᵢ but its top nodes; and
processing, by one or more computer processors, each of the K input records through a top nodes of said each decision tree Tᵢ to associate each of the K input records with a single, respective one of the subtrees of each decision tree Tᵢ, wherein K × N associations are obtained in total for the N decision trees and the K input records, and
processing, by one or more computer processors, all of the K input records by executing tensor operations, in accordance with the K × N associations obtained, to perform said machine learning inferences, wherein the tensor operations use first operands and second operands that capture feature values of the K input records and attributes of the remaining nodes of all of the subtrees formed.

2. The method of claim 1, further comprising offloading, by one or more computer processors, the tensor operations to be executed to a hardware accelerator.

3. The method of claim 2, wherein the operations are offloaded to a dedicated chip, which is specifically designed to perform tensor operations.

4. The method of claim 1, further comprising setting, by one or mor computer processors, a value M to M = 1 for each of the N decision trees, such that, for each of the N decision trees:
a one top level is identified, wherein the one top level includes a single top node that is the root node, and
two subtrees are identified, wherein each subtrees of the two subtrees includes a respective subset of the remaining nodes.

5. The method of claim 1, further comprising:
determining, by one or more computer processors, an optimal number of top levels based on computer resources available at the computerized system, such that 1 ≤ M < Min(L₁, ...., L_{N}), and
storing, by one or more computer processors, the optimal number determined as said value M.

6. The method of claim 5, wherein determining the optimal number of top levels comprises comparing an additional computational complexity induced by a processing of each of the K input records through the top nodes of each of the decision trees with a reduction of computational complexity allowed by the K × N associations obtained and the second operands used to execute the tensor operations.

7. The method of claim 1, further comprising:
loading, by one or more computer processors, one or more first arrays capturing feature values of the K input records for use by the first operands and one or more further arrays capturing the attributes of the remaining nodes of all of the subtrees formed, for use by the second operands, wherein the one or more further arrays include second arrays capturing attributes of internal nodes of the subtrees and third arrays capturing attributes of leaf nodes of the subtrees.

8. The method of claim 7, wherein:
the one or more first arrays comprise an array x for each input record of the K input records, the array x reflecting a row vector X including the feature values of said each input record; and
the one or more second arrays comprise two arrays for each subtree of all of the subtrees formed, wherein the two arrays comprise an array a reflecting a matrix A having a number of columns corresponding to a number of split nodes of said each subtree and an array b reflecting a row vector B of first comparands, and
wherein the third arrays comprise three arrays for said each subtree, wherein the three arrays comprise an array c reflecting a matrix C having a number of columns corresponding to a number of leaf nodes of said each subtree, an array d reflecting a row vector D of second comparands and an array e reflecting a matrix E encoding potential inference results, and wherein
executing the tensor operations further comprises, for said each input record and said each subtree, decomposing, by one or more computer processors, the tensor operations into a sequence of five operations, the five operations including:
a dot product of the row vector X by the matrix A, the dot product resulting in a first result as a row vector;
a comparison of this first result to the row vector B, to obtain a second result as an array y encoding an outcome of this comparison, the array y reflecting a row vector Y;
a dot product of the row vector Y by the matrix C, this dot product resulting in a third result as a row vector;
a comparison of this third result with the row vector D, to obtain a fourth result as an array z encoding an outcome of this comparison, the array z reflecting a row vector Z; and
a dot product of the row vector Z by the matrix E, this resulting in a fifth result as a row vector, based on which an inference result is formulated for said each subtree with respect to said each input record.

9. The method of claim 7, further comprising:
building, by one or more computer processors, a tensor representation of the machine learning inferences based on statistics on nodes of the N decision trees and the further arrays, to be performed by forming complementary tensor subsets that respectively correspond to complementary subsets of the leaf nodes of all of the subtrees formed, wherein
the complementary tensor subsets are ranked such that a first tensor subset and a second tensor subset of the complementary tensor subsets correspond to a first leaf node subset and a second leaf node subset of the complementary leaf node subsets, respectively, and
the leaf nodes of the first leaf node subset are more likely to be reached than the leaf nodes of the second leaf node subset according to the statistics accessed; and executing the tensor operations comprises:
processing, by one or more computer processors, all of the K input records by performing tensor operations of the first tensor subset, in accordance with the K × N associations obtained, to obtain first inference results for a first subset of the K input records, in accordance with leaf nodes of the first leaf node subset, whereby remaining input records, for which no inference result has yet been obtained, form a second subset of the K input records; and
processing, by one or more computer processors, all of the input records of the second subset of the K input records, in accordance with a corresponding subset of the K × N associations obtained, by performing the tensor operations of the second tensor subset to obtain second inference results for the second subset of the input records in accordance with leaf nodes of the second leaf node subset.

10. The method of claim 9, wherein the complementary tensor subsets are formed by
reordering, by one or more computer processors, one or more columns of the third arrays according to the statistics accessed, the columns corresponding to respective leaf nodes of the subtrees, and
splitting, by one or more computer processors, the one or more columns of the third arrays as reordered to obtain complementary subarrays, these including first subarrays and second subarrays, whereby
the first tensor subset is formed based on the first subarrays, and
the second tensor subset is formed based on the second subarrays.

11. The method of claim 10, wherein the third arrays, once reordered, are split according to at least one threshold value in respect of the statistics accessed for the leaf nodes.

12. The method of claim 1, wherein
the N decision trees form an ensemble model, and
the machine learning inferences are performed to obtain an ensemble result for each of the K input records.

13. The method of claim 1, wherein
each of the N decision trees is a binary tree and each ensemble result obtained is one of a binary classification result and a regression result.

14. A computer system for performing machine learning inferences on K input records, K ≥ 2, based on N decision trees, N ≥ 2, wherein each decision tree Tᵢ of the N decision trees has nodes extending from a root node to leaf nodes across Lᵢ levels, the computer system comprising:
one or more computer processors;
one or more computer readable storage media; and
program instructions stored on the one or more computer readable storage media for execution by at least one of the one or more computer processors, the program instructions comprising:
program instructions to access a value M identifying M top levels of one or more N decision trees, wherein 1 ≤ M < Min(L₁, ...., L_{N}) and wherein a M top levels defines top nodes for each of the N decision trees, and wherein for each decision tree Tᵢ of the N decision trees:
program instructions to identify one or more subtrees subtended by respective subsets of remaining nodes of each decision tree Ti, a remaining nodes including all of the nodes of said each decision tree Tᵢ but its top nodes; and
program instructions to process each of the K input records through a top nodes of said each decision tree Tᵢ to associate each of the K input records with a single, respective one of the subtrees of each decision tree Tᵢ, wherein K × N associations are obtained in total for the N decision trees and the K input records, and
program instructions to process all of the K input records by executing tensor operations, in accordance with the K × N associations obtained, to perform said machine learning inferences, wherein the tensor operations use first operands and second operands that capture feature values of the K input records and attributes of the remaining nodes of all of the subtrees formed.

15. The computer system of claim 14, further comprising program instructions to offload the tensor operations to be executed to a hardware accelerator.

16. The computer system of claim 15, wherein the operations are offloaded to a dedicated chip, which is specifically designed to perform tensor operations.

17. The computer system of claim 14, further comprising program instructions stored on the one or more computer readable storage media for execution by at least one of the one or more computer processors, to:
determine, prior to accessing the value M, an optimal number of top levels based on computer resources available at the computerized system, such that 1 ≤ M < Min(L₁, ...., L_{N}), and
instruct to store the optimal number determined as said value M.

18. A computer program product for performing machine learning inferences on K input records, K ≥ 2, based on N decision trees, N ≥ 2, wherein each decision tree Tᵢ of the N decision trees has nodes extending from a root node to leaf nodes across Lᵢ levels, the computer program product comprising:
one or more computer readable storage media; and
program instructions stored on the one or more computer readable storage media, the program instructions comprising:
program instructions to access a value M identifying M top levels of one or more N decision trees, wherein 1 ≤ M < Min(L₁, ...., L_{N}) and wherein a M top levels defines top nodes for each of the N decision trees, and wherein for each decision tree Tᵢ of the N decision trees:
program instructions to identify one or more subtrees subtended by respective subsets of remaining nodes of each decision tree Ti, a remaining nodes including all of the nodes of said each decision tree Tᵢ but its top nodes; and
program instructions to process each of the K input records through a top nodes of said each decision tree Tᵢ to associate each of the K input records with a single, respective one of the subtrees of each decision tree Tᵢ, wherein K × N associations are obtained in total for the N decision trees and the K input records, and
program instructions to process all of the K input records by executing tensor operations, in accordance with the K × N associations obtained, to perform said machine learning inferences, wherein the tensor operations use first operands and second operands that capture feature values of the K input records and attributes of the remaining nodes of all of the subtrees formed.

19. The computer program product of claim 18, further comprising program instructions to offload the tensor operations to be executed to a hardware accelerator.

20. The computer program product of claim 19, wherein the operations are offloaded to a dedicated chip, which is specifically designed to perform tensor operations.
